(19) United States
(12) Patent Application Publication
(10) Pub. No.: US 2023/0182732 A1
(43) Pub. Date: Jun. 15, 2023

(54) ELECTRONIC CONTROL DEVICE

(71) Applicant: Hitachi Astemo, Ltd., Hitachinaka-shi, Ibaraki (JP)

(72) Inventors: Yuki HORITA, Tokyo (JP); Hidehiro TOYODA, Hitachinaka-shi (JP)

(73) Assignee: Hitachi Astemo, Ltd., Hitachinaka-shi, Ibaraki (JP)

(21) Appl. No.: 17/926,215

(22) PCT Filed: Feb. 1, 2021
(86) PCT No.: PCT/JP2021/003607

§ 371 Date: Nov. 18, 2022

(30) Foreign Application Priority Data
May 29, 2020 (JP) 2020-095104

(51) Int. Cl. B60W 30/16; B60W 40/02; B60W 60/00

(52) U.S. Cl. CPC B60W 30/16; B60W 40/02; B60W 60/00; B60W 2554/4041; B60W 2554/80; B60W 2420/50

(57) ABSTRACT

An electronic control device mounted on a vehicle includes: a sensor detectable zone-determining unit that determines a sensor detectable zone representing a zone where an environmental element present around the vehicle is detectable by a sensor mounted on the vehicle based on detection information of the sensor; a cruise control information-generating unit that generates cruise control information for the vehicle based on the detection information of the sensor and the sensor detectable zone determined by the sensor detectable zone-determining unit; and an information output unit that outputs the cruise control information generated by the cruise control information-generating unit.

### TECHNICAL FIELD

The present invention relates to an electronic control device.

### BACKGROUND ART

In recent years, in order to implement comfortable and safe driving assistance and automated driving of a vehicle, there has been proposed a technology of detecting degradation in performance of an external environment sensor that recognizes a surrounding environment of the vehicle, and implementing fail-soft and safe stop of the automated driving. For example, PTL 1 discloses means for decreasing a traveling speed or safely stopping by detecting performance degradation due to contamination or failure of an external environment sensor.

### CITATION LIST

### Patent Literature

PTL 1: WO 2015/068249 A

### SUMMARY OF INVENTION

### Technical Problem

In the invention described in PTL 1, the presence or absence of a change in pixel output value of a camera is used to detect performance degradation due to contamination or failure of the camera, and an operation mode such as a fail-soft operation or a safe stop operation is determined according to the state.

Meanwhile, performance of an external environment sensor may be degraded due to not only contamination or failure of the sensor itself but also a change in external environment. For example, in a case where a camera or light detection and ranging (LiDAR) is used as the external environment sensor, distance performance that enables detecting an obstacle is degraded under bad weather such as heavy rain or fog. In addition, it is known that performance in detecting a distant obstacle at the time of heavy rain is lower than that at the time of normal weather also in a case where a millimeter wave radar that is said to be resistant to bad weather is used as the external environment sensor. As described above, in a case where the performance of the external environment sensor is degraded due to an external environmental factor, the performance degradation of the external environment sensor cannot be detected with the method disclosed in PTL 1.

In addition, the external environment continuously changes from moment to moment, and the degree of performance degradation of the external environment sensor continuously changes accordingly. However, in a case of determining a driving mode by discretely determining the level of performance degradation of the external environment sensor as in PTL 1, it is difficult to perform flexible cruise control according to a change in external environment. Therefore, the driving mode is set in such a way as to give greater weight to safety, and there is a possibility that the condition under which automated driving can be continued is limited more than originally intended.

In order to solve the above-described problems in the related art, an object of the present invention is to provide an electronic control device capable of flexibly and safely continuing cruise control in spite of performance degradation of a sensor due to a change in external environment.

### Solution to Problem

An electronic control device according to a first aspect of the present invention is mounted on a vehicle, and includes: a sensor detectable zone-determining unit that determines a sensor detectable zone representing a zone where an environmental element present around the vehicle is detectable by a sensor mounted on the vehicle based on detection information of the sensor; a cruise control information-generating unit that generates cruise control information for the vehicle based on the detection information of the sensor and the sensor detectable zone determined by the sensor detectable zone-determining unit; and an information output unit that outputs the cruise control information generated by the cruise control information-generating unit. An electronic control device according to a second aspect of the present invention is mounted on a vehicle, and includes: a surroundings detectable zone-determining unit that determines a surroundings detectable zone representing a zone where an environmental element present around the vehicle is detectable based on detection information of a sensor mounted on the vehicle; a cruise control information-generating unit that generates cruise control information for the vehicle based on the detection information of the sensor and the surroundings detectable zone determined by the surroundings detectable zone-determining unit; and an information output unit that outputs the cruise control information generated by the cruise control information-generating unit.

### Advantageous Effects of Invention

According to the present invention, it is possible to provide an electronic control device capable of flexibly and safely continuing cruise control in spite of performance degradation of a sensor due to a change in external environment.

### BRIEF DESCRIPTION OF DRAWINGS

FIG. 1 is a functional block diagram illustrating a configuration of a vehicle system including a cruise control device according to an embodiment of the present invention.

FIG. 2 is a conceptual diagram of a sensor detectable zone.

FIG. 3 is a diagram illustrating an example of sensor detection information.

FIG. 4 is a diagram illustrating an example of the sensor detectable zone.

FIG. 5 is a diagram illustrating an example of a surroundings detectable zone.

FIG. 6 is a diagram illustrating a correlation between functions implemented by the cruise control device according to the embodiment of the present invention.

FIG. 7 is a flowchart for describing processing performed by a sensor detectable zone-determining unit.

FIG. 8 is a diagram illustrating an example of a method of calculating information on a correlation between a detection distance and a reliability.

FIG. 9 is a diagram illustrating an example of a surroundings detectable zone and a surroundings redundancy detectable zone.

FIG. 10 is a diagram illustrating an example of traveling environment detection performance requirement information.

FIG. 11 is a flowchart for describing processing performed by a cruise control mode-picking unit.

FIG. 12 is a diagram illustrating an example of a surroundings detectable zone that changes according to an external environment.

FIG. 13 is a diagram illustrating an example of a method of calculating a target speed according to the surroundings detectable zone.

### DESCRIPTION OF EMBODIMENTS

Hereinafter, embodiments of the present invention will be described with reference to the drawings.

(System Configuration)

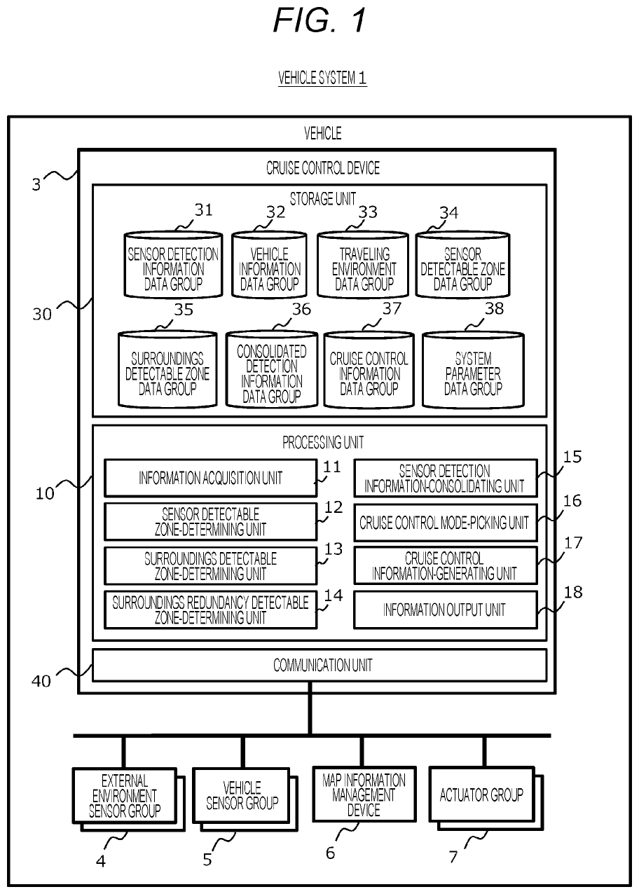

FIG. 1 is a functional block diagram illustrating a configuration of a vehicle system 1 including a cruise control device 3 according to an embodiment of the present invention. The vehicle system 1 is mounted on a vehicle 2. The vehicle system 1 recognizes a situation of an obstacle such as a traveling road or a surrounding vehicle around the vehicle 2, and then performs appropriate driving assistance and cruise control. As illustrated in FIG. 1, the vehicle system 1 includes a cruise control device 3, an external environment sensor group 4, a vehicle sensor group 5, a map information management device 6, an actuator group 7, and the like. The cruise control device 3, the external environment sensor group 4, the vehicle sensor group 5, the map information management device 6, and the actuator group 7 are connected to each other by an in-vehicle network N. Hereinafter, the vehicle 2 may be referred to as an “own vehicle” 2 in order to be distinguished from other vehicles.

The cruise control device 3 is an electronic control unit (ECU). The cruise control device 3 generates cruise control information for driving assistance or automated driving of the vehicle 2 based on various input information provided from the external environment sensor group 4, the vehicle sensor group 5, the map information management device 6, and the like, and outputs the cruise control information to the actuator group 7 and the like. The cruise control device 3 includes a processing unit 10, a storage unit 30, and a communication unit 40.

The processing unit 10 includes, for example, a central processing unit (CPU). However, the processing unit 10 may include, in addition to the CPU, a graphics processing unit (GPU), a field-programmable gate array (FPGA), an application specific integrated circuit (ASIC), or the like, or may be implemented by any one of them.

The processing unit 10 includes, as functions thereof, an information acquisition unit 11, a sensor detectable zone-determining unit 12, a surroundings detectable zone-determining unit 13, a surroundings redundancy detectable zone-determining unit 14, a sensor detection information-consolidating unit 15, a cruise control mode-picking unit 16, a cruise control information-generating unit 17, and an information output unit 18. The processing unit 10 implements these functions by executing a predetermined operation program stored in the storage unit 30.

The information acquisition unit 11 acquires various information from other devices connected to the cruise control device 3 via the in-vehicle network N, and stores the information in the storage unit 30. For example, the information acquisition unit 11 acquires information regarding an observation point around the vehicle 2 detected by the external environment sensor group 4 and information regarding an environmental element such as an obstacle, a road marking, a sign, or a signal around the vehicle 2 estimated based on the information regarding the observation point, and stores, in the storage unit 30, the information as a sensor detection information data group 31 representing detection information of the external environment sensor group 4. In addition, the information acquisition unit 11 acquires information related to a movement, a state, and the like of the vehicle 2 detected by the vehicle sensor group 5 and the like, and stores, in the storage unit 30, the information as a vehicle information data group 32. In addition, the information acquisition unit 11 acquires information related to a traveling environment and a traveling route of the vehicle 2 from the map information management device 6 or the like, and stores, in the storage unit 30, the information as a traveling environment data group 33.

The sensor detectable zone-determining unit 12 determines a sensor detectable zone representing a detectable zone of the external environment sensor group 4 based on the sensor detection information data group 31 acquired by the information acquisition unit 11 and stored in the storage unit 30. For example, the sensor detectable zone-determining unit 12 determines, as the sensor detectable zone, a detectable zone of a single individual sensor included in the external environment sensor group 4 or a detectable zone of a combination of a plurality of homogeneous individual sensors. Hereinafter, a combination (including a single sensor) of external environment sensors for which the sensor detectable zone is determined is referred to as a “sensor group”. The sensor detectable zone-determining unit 12 determines the sensor detectable zone for each sensor group, and stores, in the storage unit 30, information on each determined sensor detectable zone as a sensor detectable zone data group 34.

The sensor detectable zone means a zone where, in a case where an environmental element such as an obstacle, a road marking, a sign, or a signal is present in the zone, the sensor group can detect the environmental element with a sufficiently high probability. In other words, the sensor detectable zone is a zone where a probability that the sensor group does not detect the environmental element is sufficiently low, and in a case where the sensor group does not detect an environmental element such as an obstacle to be detected in this zone, it can be regarded that the environmental element to be detected does not exist in this zone. Each sensor included in the external environment sensor group 4 often statically defines the sensor detectable zone as a product specification, but the sensor detectable zone actually changes according to the external environment. The sensor detectable zone-determining unit 12 dynamically estimates the sensor detectable zone at that time based on information on a detection position and a detection reliability of an obstacle included in the detection information of each sensor group.

The surroundings detectable zone-determining unit 13 determines a surroundings detectable zone which is a zone where an environmental element such as an obstacle around the vehicle 2 can be detected by using the external environment sensor group 4 based on the sensor detectable zone (sensor detectable zone data group 34) of each sensor group determined by the sensor detectable zone-determining unit 12. As described above, the sensor detectable zone-determining unit 12 determines the detectable zone of each sensor group of the external environment sensor group 4 as the sensor detectable zone, but the surroundings detectable zone-determining unit 13 determines, as the surroundings detectable zone, a zone where an environmental element such as an obstacle can be detected with a sufficiently high probability in a case where all the sensor groups of the external environment sensor group 4 are combined, that is, a zone where an environmental element can be detected by at least one sensor group of the external environment sensor group 4.

The surroundings redundancy detectable zone-determining unit 14 determines, based on the sensor detectable zone data group 34, a surroundings redundancy detectable zone which is a zone where an environmental element such as an obstacle around the vehicle 2 can be redundantly detected by two or more sensor groups of the external environment sensor group 4. As described above, the surroundings detectable zone-determining unit 13 determines, as the surroundings detectable zone, a zone where an environmental element can be detected by at least one sensor group of the external environment sensor group 4, but the surroundings redundancy detectable zone-determining unit 14 determines, as the surroundings redundancy detectable zone, a zone where an environmental element can be redundantly detected by two or more sensor groups of the external environment sensor group 4. That is, the surroundings redundancy detectable zone is a zone corresponding to a portion where a plurality of sensor detectable zones overlap each other in the surroundings detectable zone.

The surroundings detectable zone-determining unit 13 store information on the surroundings detectable zone and the surroundings redundancy detectable zone-determining unit 14 store information on the surroundings redundancy detectable zone in the storage unit 30 as a surroundings detectable zone data group 35, the surroundings detectable zone being determined by the surroundings detectable zone-determining unit 13, and the surroundings redundancy detectable zone being determined by the surroundings redundancy detectable zone-determining unit 14.

The sensor detection information-consolidating unit 15 generates consolidated detection information regarding an environmental element such as an obstacle, a road marking, a sign, or a signal around the vehicle 2 based on the sensor detection information data group 31 acquired by the information acquisition unit 11 and stored in the storage unit 30. Processing performed by the sensor detection information-consolidating unit 15 corresponds to, for example, a function generally called sensor fusion. The consolidated detection information generated by the sensor detection information-consolidating unit 15 is stored in the storage unit 30 as a consolidated detection information data group 36.

The cruise control mode-picking unit 16 picks a cruise control mode of the vehicle system 1 in which the vehicle 2 can safely travel, based on a system state (a failure state, an occupant instruction mode, or the like) of the vehicle system 1 or the cruise control device 3, performance requirements of the external environment sensor group 4 for the traveling environment, states of the surroundings detectable zone and the surroundings redundancy detectable zone determined by the surroundings detectable zone-determining unit 13 and the surroundings redundancy detectable zone-determining unit 14, respectively. Information on the cruise control mode picked by the cruise control mode-picking unit 16 is stored in the storage unit 30 as a part of a system parameter data group 38.

The cruise control information-generating unit 17 generates cruise control information for the vehicle 2 based on the surroundings detectable zone and the surroundings redundancy detectable zone generated by the surroundings detectable zone-determining unit 13 and the surroundings redundancy detectable zone-determining unit 14, respectively, the consolidated detection information generated by the sensor detection information-consolidating unit 15, the cruise control mode picked by the cruise control mode-picking unit 16, and the like. For example, a trajectory on which the vehicle 2 should travel is planned based on these pieces of information, and a control command value to be output to the actuator group 7 for following the planned trajectory is determined. Then, the cruise control information is generated using the determined planned trajectory and control command value, and a result of picking the cruise control mode by the cruise control mode-picking unit 16. The cruise control information generated by the cruise control information-generating unit 17 is stored in the storage unit 30 as a cruise control information data group 37.

The information output unit 18 outputs the cruise control information generated by the cruise control information-generating unit 17 to another device connected to the cruise control device 3 via the in-vehicle network N. For example, the cruise control device 3 outputs the cruise control information including the control command value determined by the cruise control information-generating unit 17 to the actuator group 7 to perform cruise control for the vehicle 2. In addition, for example, the cruise control device 3 outputs the cruise control information including the cruise control mode picked by the cruise control mode-picking unit 16 to another device so that the vehicle system 1 can shift to a matching system mode as a whole.

The storage unit 30 includes, for example, a storage device such as a hard disk drive (HDD), a flash memory, or a read only memory (ROM), and a memory such as a random access memory (RAM). The storage unit 30 stores a program to be processed by the processing unit 10, a data group necessary for the processing, and the like. In addition, as a main storage when the processing unit 10 executes the program, the storage unit 30 is also used for temporarily storing data necessary for operation of the program. In the present embodiment, as information for implementing the functions of the cruise control device 3, the sensor detection information data group 31, the vehicle information data group 32, the traveling environment data group 33, the sensor detectable zone data group 34, the surroundings detectable zone data group 35, the consolidated detection information data group 36, the cruise control information data group 37, the system parameter data group 38, and the like are stored in the storage unit 30.

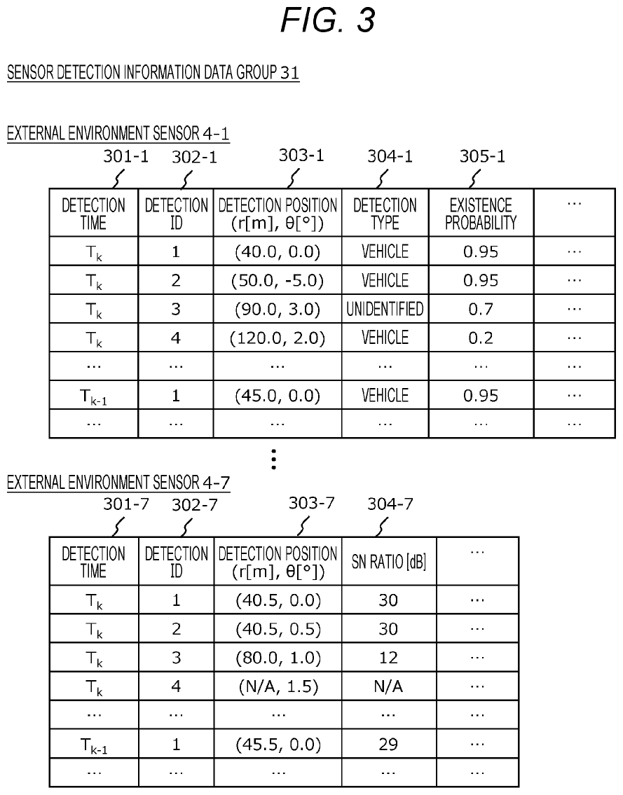

The sensor detection information data group 31 is a set of data regarding the detection information from the external environment sensor group 4, and a reliability thereof. The detection information is, for example, information regarding an environmental element such as an obstacle, a road marking, a sign, or a signal specified by the external environment sensor group 4 based on observation information of the sensing, or observation information of the external environment sensor group 4 itself (point cloud information of LiDAR, FFT information of a millimeter wave radar, a camera image, a parallax image of a stereo camera, or the like). The reliability of the detection information corresponds to the degree of accuracy of existence (existence probability) of the information regarding an environmental element detected by the sensor and the observation information, and differs depending on the type of the sensor and the product specification. For example, in a case of a sensor such as LiDAR or a millimeter wave radar that observes reflected waves, the reliability may be expressed using a reception strength or signal-to-noise ratio (SN ratio) thereof, may be calculated according to how many times the observation can be performed continuously in time series, or may be any index as long as it is an index related to the degree of accuracy of the detection information. A data expression example of the sensor detection information in the sensor detection information data group 31 will be described later with reference to FIG. 3. The sensor detection information data group 31 is acquired from the external environment sensor group 4 by the information acquisition unit 11 and stored in the storage unit 30.

The vehicle information data group 32 is a set of data regarding the movement, the state, and the like of the vehicle 2. The vehicle information data group 32 includes, as vehicle information detected by the vehicle sensor group 5 and the like and acquired by the information acquisition unit 11, for example, information such as a position, a traveling speed, a steering angle, an accelerator operation amount, a brake operation amount, and the like of the vehicle 2.

The traveling environment data group 33 is a set of data regarding a traveling environment of the vehicle 2. The data regarding the traveling environment is information regarding roads around the vehicle 2 including a road on which the vehicle 2 is traveling. The data regarding the traveling environment includes, for example, information regarding a traveling route of the vehicle 2, a road on the traveling route or a road around the vehicle 2, and a shape or an attribute (a traveling direction, a speed limit, a traveling regulation, or the like) of a lane of the road.

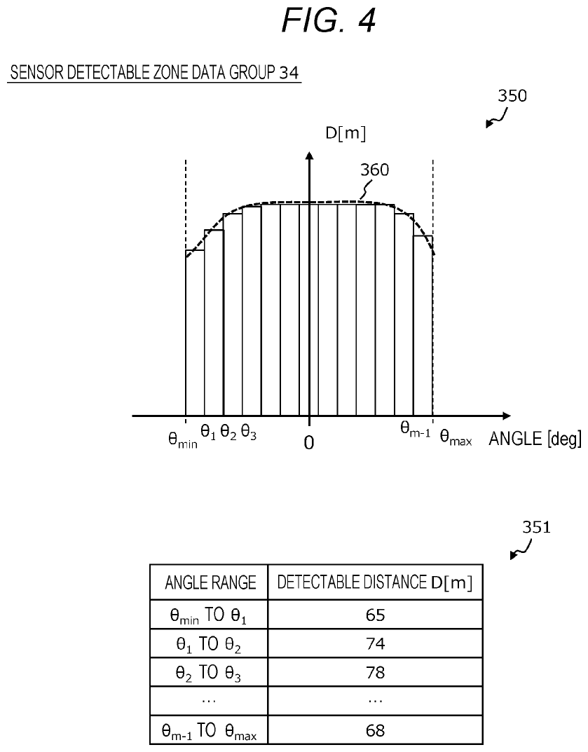

The sensor detectable zone data group 34 is a set of data regarding the sensor detectable zone which is a zone where an environmental element such as an obstacle can be detected for each sensor group of the external environment sensor group 4. An expression example of the data regarding the sensor detectable zone in the sensor detectable zone data group 34 will be described later with reference to FIG. 4. The sensor detectable zone data group 34 is generated and stored by the sensor detectable zone-determining unit 12 based on the information of the sensor detection information data group 31 acquired by the information acquisition unit 11.

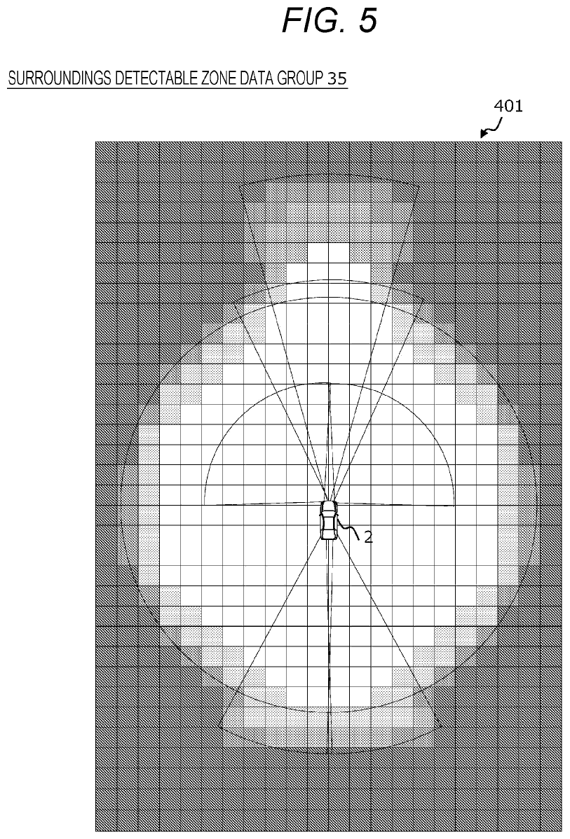

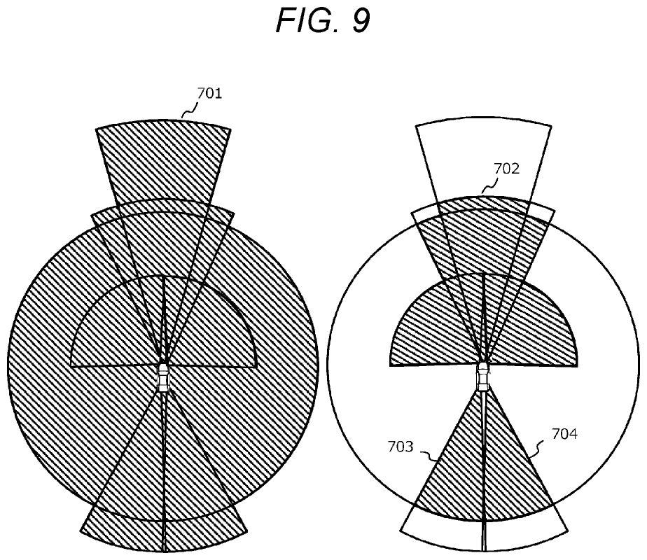

The surroundings detectable zone data group 35 is a set of data regarding the surroundings detectable zone which is a zone where an environmental element such as an obstacle can be detected using all the sensor groups of the external environment sensor group 4 and the surroundings redundancy detectable zone which is a zone where an environmental element such as an obstacle can be redundantly detected using a plurality of sensor groups of the external environment sensor group 4. An expression example of the data regarding the surroundings detectable zone and the surroundings redundancy detectable zone in the surroundings detectable zone data group 35 will be described later with reference to FIGS. 5 and 9. The surroundings detectable zone data group 35 is generated and stored by the surroundings detectable zone-determining unit 13 and the surroundings redundancy detectable zone-determining unit 14 based on the information of the sensor detectable zone data group 34.

The consolidated detection information data group 36 is a set of data of the consolidated detection information related to an environmental element around the vehicle 2, which is determined in a consolidated manner based on the detection information of the external environment sensor group 4. The consolidated detection information data group 36 is generated and stored by the sensor detection information-consolidating unit 15 based on the information of the sensor detection information data group 31.

The cruise control information data group 37 is a data group regarding plan information for cruise control for the vehicle 2, and includes the planned trajectory and the cruise control mode of the vehicle 2, the control command value to be output to the actuator group 7, and the like. These pieces of information in the cruise control information data group 37 are generated and stored by the cruise control information-generating unit 17.

The system parameter data group 38 is a set of data regarding the system state (the cruise control mode, the failure state, the occupant instruction mode, or the like) of the vehicle system 1 or the cruise control device 3, a detection performance requirement for the traveling environment, and the like.

The communication unit 40 has a function for communication with other devices connected via the in-vehicle network N. The communication function of the communication unit 40 is used when the information acquisition unit 11 acquires various information from other devices via the in-vehicle network N or when the information output unit 18 outputs various information to other devices via the in-vehicle network N. The communication unit 40 includes, for example, a network card or the like conforming to a communication standard such as IEEE 802.3 or a controller area network (CAN). The communication unit 40 transmits and receives data to and from the cruise control device 3 and other devices in the vehicle system 1 based on various protocols.

Note that, in the present embodiment, the communication unit 40 and the processing unit 10 are described separately, but a part of the processing performed by the communication unit 40 may be performed by the processing unit 10. For example, hardware devices for the communication processing are located in the communication unit 40, and other device driver groups, communication protocol processing, and the like are located in the processing unit 10.

The external environment sensor group 4 is an assembly of devices that detect the state around the vehicle 2. The external environment sensor group 4 corresponds to, for example, various sensors such as a camera device, a millimeter wave radar, LiDAR, and sonar. The external environment sensor group 4 outputs the observation information of the sensing and the information regarding an environmental element such as an obstacle, a road marking, a sign, and a signal specified based on the observation information to the cruise control device 3 via the in-vehicle network N. The “obstacle” is, for example, another vehicle that is a vehicle other than the vehicle 2, a pedestrian, a falling object on a road, a road edge, or the like. The “road marking” is, for example, a white line, a crosswalk, a stop line, or the like.

The vehicle sensor group 5 is an assembly of devices that detect various states of the vehicle 2. Each vehicle sensor detects, for example, position information, a traveling speed, a steering angle, an accelerator operation amount, a brake operation amount, and the like of the vehicle 2, and outputs the detected information to the cruise control device 3 via the in-vehicle network N.

The map information management device 6 is a device that manages and provides digital map information around the vehicle 2 and information regarding a traveling route of the vehicle 2. The map information management device 6 includes, for example, a navigation device or the like. The map information management device 6 includes, for example, digital road map data of a predetermined region including the surroundings of the vehicle 2, and is configured to specify the current position of the vehicle 2 on the map, that is, a road or lane on which the vehicle 2 is traveling, based on the position information of the vehicle 2 output from the vehicle sensor group 5 and the like. In addition, the specified current position of the vehicle 2 and map data around the vehicle 2 are output to the cruise control device 3 via the in-vehicle network N.

The actuator group 7 is a device group that controls a control element such as steering, a brake, and an accelerator that determine the movement of the vehicle. The actuator group 7 controls the movement of the vehicle based on information on operation of a steering wheel, a brake pedal, an accelerator pedal, and the like by a driver and the control command value output from the cruise control device 3.

(Sensor Detectable Zone)

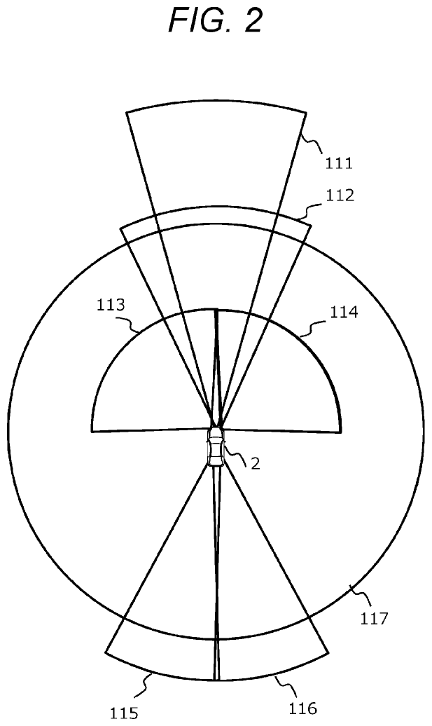

FIG. 2 is a conceptual diagram of the sensor detectable zone by the external environment sensor group 4 mounted on the vehicle 2. FIG. 2 illustrates an example for describing the sensor detectable zone, but actually, the external environment sensor group 4 is installed in such a way as to satisfy the detection performance requirement for an automated driving function of the vehicle system 1.

In the example of FIG. 2, six sensors (external environment sensors 4-1 to 4-7) are installed in the vehicle 2, and rough sensor detectable zones thereof are indicated by zones 111 to 117. For example, the external environment sensor 4-1 corresponding to the zone 111 is implemented by a long-range millimeter wave radar, the external environment sensor 4-2 corresponding to the zone 112 is implemented by a camera-based sensor, the external environment sensors 4-3 to 4-6 corresponding to the zones 113 to 116 are implemented by short-range millimeter wave radars, and the external environment sensor 4-7 corresponding to the zone 117 is implemented by LiDAR. Here, for the sake of simplicity, the sensor detectable zones 111 to 117 are expressed in a fan shape around the vehicle 2, but in practice, the sensor detectable zone can be expressed in an arbitrary shape according to the detection range of each sensor. Note that the size and shape of the sensor detectable zone change according to the external environment.

(Sensor Detection Information)

FIG. 3 is a diagram illustrating an example of the sensor detection information stored in the sensor detection information data group 31. Here, an example of a data structure of the sensor detection information of the external environment sensor 4-1 (long-range millimeter wave radar) is illustrated as an example of a data structure in a case where an external environment sensor outputs information regarding an environmental element specified based on the observation information, and an example of a data structure of the sensor detection information of the external environment sensor 4-7 (LiDAR) is illustrated as an example of a data structure in a case where an external environment sensor outputs the observation information.

The sensor detection information data of the external environment sensor 4-1 includes a detection time 301-1, a detection ID 302-1, a detection position 303-1, a detection type 304-1, an existence probability 305-1, and the like.

The detection time 301-1 is information regarding a timing at which detection information of a corresponding entry has been detected. This information may be time information, or may be a number indicating which cycle the detection information of the entry corresponds to, in a case where the external environment sensor 4-1 is a sensor that periodically performs detection.

The detection ID 302-1 is an ID for identifying each detection information entry. The detection ID 302-1 may be set in such a way as to assign a common ID to the same detection target object in time series, or may be set to a serial number for each cycle.

The detection position 303-1 is information regarding a position where an environment element corresponding to the detection information of the entry is present. In FIG. 3, polar coordinates expressed by a distance r and an angle θ in a reference coordinate system of the sensor are used, but an orthogonal coordinate system may be used.

The detection type 304-1 indicates the type of an environment element indicated by the detection information of the entry. Examples of the detection type 304-1 include a vehicle, a pedestrian, a white line, a sign, a signal, a road edge, and an unidentified object.

The existence probability 305-1 is information indicating with what probability an environment element corresponding to the detection information of the entry exists. For example, in a case of a millimeter wave radar, when the SN ratio decreases, it becomes difficult to distinguish a reflected wave from an environmental element to be detected from noise, and a possibility of erroneous detection thus increases. The external environment sensor 4-1 calculates and sets the existence probability (or an index corresponding thereto) based on the SN ratio and a detection state in time series in processing of specifying an environmental element.

The sensor detection information data of the external environment sensor 4-7 includes a detection time 301-7, a detection ID 302-7, a detection position 303-7, an SN ratio 304-7, and the like.

The detection time 301-7, the detection ID 302-7, and the detection position 303-7 are equivalent to the detection time 301-1, the detection ID 302-1, and the detection position 303-1 described above, respectively.

The SN ratio 304-7 indicates an SN ratio when the observation information of the entry is observed. Note that, here, the SN ratio is exemplified as information corresponding to the reliability of the observation information, but a reception strength or the like may also be used.

(Sensor Detectable Zone)

FIG. 4 is a diagram illustrating an example of the sensor detectable zone indicated by the information stored in the sensor detectable zone data group 34. The sensor detectable zone is determined by the sensor detectable zone-determining unit 12 in units of sensor groups of the external environment sensor group 4. Data as illustrated in FIG. 4 is generated for each of the sensor detectable zones. Here, an example of a structure of data generated for a sensor detectable zone by a predetermined sensor group is illustrated.

The respective sensors of the external environment sensor group 4 may have a performance difference depending on the angle of a detection target. For example, performance of a camera-based sensor deteriorates at a boundary of an angle of view. Therefore, in the data of the sensor detectable zone, preferably, a detectable distance D is calculated according to a detection angle.

A graph 350 of FIG. 4 visualizes the detectable distance D calculated for a detectable angle range (θmin to θmax) of a certain sensor. A broken line 360 indicates an envelope of the graph 350, which indicates a correlation between a detection angle and a detectable distance in the sensor detectable zone by the sensor. In practice, the detectable angle range is divided for each predetermined angle range (divided into m in FIG. 4), and the detectable distance D in each divided range is calculated. A table 351 of FIG. 4 shows an example of a data structure representing the sensor detectable zone corresponding to the graph 350.

Here, the sensor detectable zone is expressed in the form of a correlation between the detection angle and the detectable distance, but the expression form is not limited thereto. The sensor detectable zone may be expressed by indicating a probability that the sensor can detect an environmental element such as an obstacle at each cell position on a grid map as described later with reference to FIG. 5. That is, the sensor detectable zone may be expressed as a boundary between a zone where the sensor can detect the detection target and a zone where the sensor cannot detect the detection target, or may be expressed as a detectability of the detection target by the sensor with respect to a predetermined zone.

In addition, although an example of data regarding the detectable distance calculated for each angle range is illustrated here, the detectable distance may be more preferably calculated according to the type of an environmental element to be detected. In a case of a sensor such as a millimeter wave radar or LiDAR that observes reflected waves of electromagnetic waves, the reception strength and the SN ratio change depending on a reflectance of the electromagnetic waves of a target object. Therefore, the detectable distance may change depending on the type of a target object. Therefore, by calculating the detectable distance according to the type of a target object, the accuracy of the detectable zone is improved, and the detectable zone can be selectively used in different applications according to the type of a target object.

(Surroundings Detectable Zone)

FIG. 5 is a diagram illustrating an example of the surroundings detectable zone indicated by the information stored in the surroundings detectable zone data group 35.

The surroundings detectable zone data group 35 represents information on the surroundings detectable zone which is a zone where an environmental element such as an obstacle around the vehicle 2 can be detected using the external environment sensor group 4. The surroundings detectable zone data group 35 is generated by integrating the sensor detectable zones of the respective sensor groups of the external environment sensor group 4. FIG. 5 illustrates a grid map in which a zone around the vehicle 2 is divided into a lattice shape, in which the surroundings detectable zone is expressed by a detectability of an environmental element at each cell position. In the surroundings detectable zone data group 35, for example, data indicating the grid map as illustrated in FIG. 5 is stored as data indicating the surroundings detectable zone. In practice, a numerical value (for example, a detection probability) indicating a detectability of an environmental element in each cell is stored in the surroundings detectable zone data group 35, but in FIG. 5, the detectability in each cell is expressed by the degree of lightness or darkness of a color (the higher the detection probability, the lighter the color, and the lower the detection probability, the darker the color).

Note that, although the example in which the surroundings detectable zone data group 35 is expressed by a detectability of an environmental element in each cell has been described here, as another expression format, for example, a boundary of the surroundings detectable zone may be clearly defined, and data indicating the shape of the zone may be stored in the surroundings detectable zone data group 35. In this case, for example, it is also possible to define a zone where the detectability in each cell as described with reference to FIG. 5 is higher than a predetermined threshold as the “surroundings detectable zone” and express the shape of the boundary portion by the surroundings detectable zone data group 35.

(System Operation)

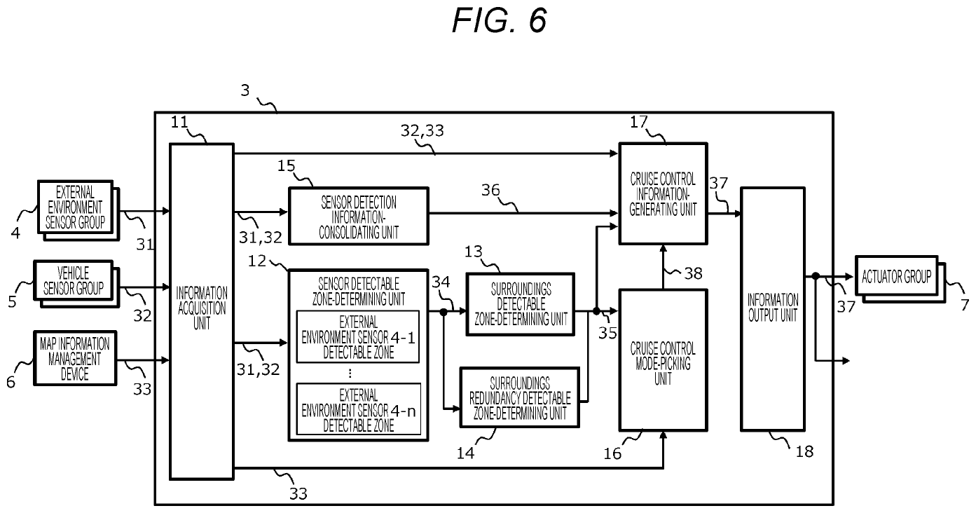

The operation of the vehicle system 1 will be described with reference to FIGS. 6 to 13. The cruise control device 3 dynamically determines the sensor detectable zone for each sensor group of the external environment sensor group 4 based on the information acquired from the external environment sensor group 4 and the like, and integrates these pieces of information to determine the surroundings detectable zone or surroundings redundancy detectable zone representing a zone where the external environment sensor group 4 can safely determine the presence or absence of an environmental element such as an obstacle around the vehicle 2. Then, based on the detection information of the external environment sensor group 4 and various detectable zones, a cruise control mode capable of maintaining safe driving in a corresponding road environment is determined, and the cruise control information for safely controlling the vehicle 2 in the cruise control mode is generated and output to the actuator group 7. The actuator group 7 controls the actuators of the vehicle 2 according to the cruise control information output from the cruise control device 3, thereby implementing cruise control for the vehicle 2. As a result, the automated driving is flexibly and safely continued in spite of the performance degradation of the sensor due to a change in external environment while meeting a performance requirement of the road environment.

FIG. 6 is a diagram illustrating a correlation between functions implemented by the cruise control device 3.

The information acquisition unit 11 acquires necessary information from other devices via the in-vehicle network N and stores the acquired information in the storage unit 30. Specifically, the sensor detection information data group 31 is acquired from the external environment sensor group 4, the vehicle information data group 32 is acquired from the vehicle sensor group 5, the traveling environment data group 33 is acquired from the map information management device 6, and these acquired data groups are stored in the storage unit 30 and delivered to a processing unit in the subsequent stage.

The sensor detectable zone-determining unit 12 determines a detectable zone for each sensor group of the external environment sensor group 4 based on the sensor detection information data group 31 and the vehicle information data group 32 acquired from the information acquisition unit 11. Then, data indicating each determined detectable zone is stored in the storage unit 30 as the sensor detectable zone data group 34 and delivered to the processing unit in the subsequent stage.

The surroundings detectable zone-determining unit 13 and the surroundings redundancy detectable zone-determining unit 14 determine the surroundings detectable zone and the surroundings redundancy detectable zone, respectively, based on the sensor detectable zone data group 34 acquired from the sensor detectable zone-determining unit 12. Then, data indicating the determined surroundings detectable zone and surroundings redundancy detectable zone is stored in the storage unit 30 as the surroundings detectable zone data group 35 and delivered to the processing unit in the subsequent stage.

The sensor detection information-consolidating unit 15 generates the consolidated detection information data group 36 obtained by consolidating detection information of a plurality of sensor groups in the external environment sensor group 4 based on the sensor detection information data group 31 and the vehicle information data group 32 acquired from the information acquisition unit 11, and stores the generated consolidated detection information data group 36 in the storage unit 30. Then, the generated consolidated detection information data group 36 is output to the cruise control information-generating unit 17.

The cruise control mode-picking unit 16 picks the cruise control mode of the vehicle 2 based on the traveling environment data group 33 acquired from the information acquisition unit 11, the surroundings detectable zone data group 35 acquired from the surroundings detectable zone-determining unit 13 and the surroundings redundancy detectable zone-determining unit 14, the system state (the failure state, the occupant instruction mode, or the like) of the vehicle system 1 or the cruise control device 3 stored in the system parameter data group 38, and the detection performance requirement for the traveling environment. Then, the picking result is stored in the storage unit 30 as a part of the system parameter data group 38 and output to the cruise control information-generating unit 17 and the information output unit 18. Note that information regarding the system parameter data group 38 can be generated by an external device or each processing unit of the cruise control device 3, but is omitted in FIG. 6.

The cruise control information-generating unit 17 determines the cruise control mode of the vehicle 2 based on the consolidated detection information data group 36 acquired from the sensor detection information-consolidating unit 15, the surroundings detectable zone data group 35 acquired from the surroundings detectable zone-determining unit 13 and the surroundings redundancy detectable zone-determining unit 14, the vehicle information data group 32 and the traveling environment data group 33 acquired from the information acquisition unit 11, the result of picking the cruise control mode of the vehicle 2 included in the system parameter data group 38 acquired from the cruise control mode-picking unit 16, and the like, plans a trajectory of the cruise control, and generates a control command value or the like for following the trajectory. Then, the cruise control information data group 37 including these pieces of information is generated, stored in the storage unit 30, and output to the information output unit 18.

The information output unit 18 outputs the cruise control information for the vehicle 2 based on the cruise control information data group 37 acquired from the cruise control information-generating unit 17. For example, the cruise control information including the control command value is output to the actuator group 7, or the cruise control information including the current cruise control mode is output to another device.

(Sensor Detectable Zone Determination Processing)

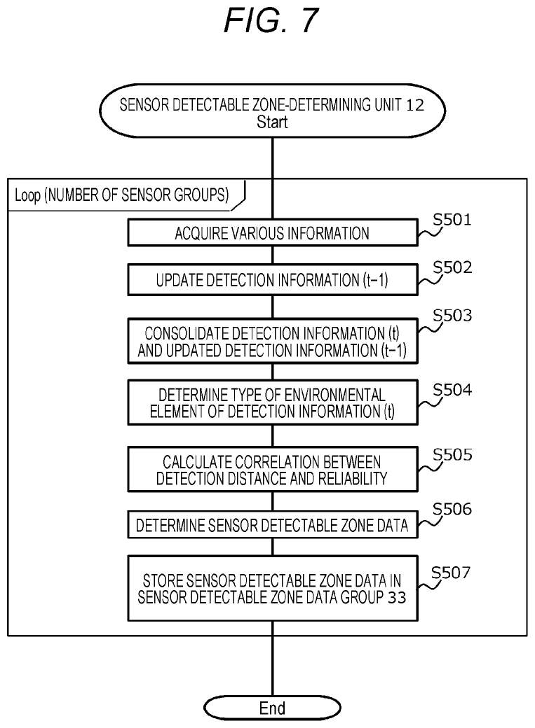

FIG. 7 is a flowchart for describing processing performed by the sensor detectable zone-determining unit 12. The sensor detectable zone-determining unit 12 performs processings of S501 to S507 for each sensor group to generate sensor detectable zone data of each sensor group, and stores the sensor detectable zone data in the storage unit 30 as the sensor detectable zone data group 34.

First, in S501, the sensor detection information data group 31 and the vehicle information data group 32 are acquired from the storage unit 30. Note that the sensor detection information data group 31 includes, in addition to the latest detection information (detection information (t)) of the external environment sensor group 4 acquired by the information acquisition unit 11, data (detection information (t−1)) related to the detection information handled by the sensor detectable zone-determining unit 12 in the previous processing.

Next, in S502, the detection information (t−1) is updated in accordance with the current state of the vehicle 2. Specifically, a state of an environmental element to be detected at a time t is predicted based on the detection information (t−1), and the prediction result is converted into an expression in a coordinate system based on the state of the vehicle 2 at the time t based on the vehicle information data group 32. As a result, in S503, prediction information obtained based on the detection information (t) in S502 and prediction information obtained based on the detection information (t−1) in S502 in the previous processing can be consolidated based on the vehicle 2, and the state of the detection target can be robustly estimated by combining the time-series information. This corresponds to, for example, processing such as a Kalman filter.

In S504, the type of the environmental element that is the detection target of the detection information (t) is determined based on the result of consolidation of the detection information performed in S503. The type of the environmental element is information corresponding to the detection type 304-1 of the sensor detection information data group 31 illustrated in FIG. 3, and corresponds to, for example, a vehicle, a pedestrian, a road surface, a white line, a road edge, a signal, an unidentified object, or the like.

The processings of S502 to S504 correspond to recognition processing using the observation information by the external environment sensor and sensor fusion processing for the detection information by the sensor detection information-consolidating unit 15. Here, it is described that the sensor detectable zone-determining unit 12 performs the same processing independently of them, but the information of the detection type 304-1 of the sensor detection information data group 31 subjected to the same processing may be used as it is. On the other hand, in a case where the observation information is output from the external environment sensor as the detection information as in the external environment sensor 4-7 in FIG. 3, the detection information does not include information regarding the detection type. Therefore, in a case of performing processing using the type of a detection target as described later, processing of consolidating the observation information and determining the type of the detection target is required as pre-stage processing. For example, this corresponds to a case where observation point information (point cloud information) of LiDAR is the detection information. However, also in this case, it is necessary for the sensor detection information-consolidating unit 15 to convert the observation information of the sensor into information regarding the environmental element to be used by the cruise control information-generating unit 17, and S502 to S504 are processings performed in the process. Therefore, the calculation result of the sensor detection information-consolidating unit 15 may be acquired and used.

Subsequently, in S505, information on the correlation between the detection distance and the reliability is statistically calculated based on the information regarding the detection position and the reliability included in the detection information. For example, in a case of the external environment sensor 4-1 in FIG. 3 in the external environment sensor group 4, the value of r of the detection position 303-1 corresponds to the detection distance, and the value of the existence probability 305-1 corresponds to the reliability. In addition, in a case of the external environment sensor 4-7 in FIG. 3, the value of r of the detection position 303-7 corresponds to the detection distance, and the value of the SN ratio 304-7 corresponds to the reliability. For example, the external environment sensor 4-1 obtains (40.0, 0.95), (50.0, 0.95), (90.0, 0.7), and the like as samples of time-series data of the combination of {detection distance, reliability}. The purpose of the information on the correlation between the detection distance and the reliability is to estimate the detection performance of the external environment sensor in the current external environment such as weather. Since the external environment does not change sharply as compared with a detection cycle of the external environment sensor group 4 or a control cycle, it is possible to treat time-series information of a predetermined time as a sample and obtain statistically sufficient samples.

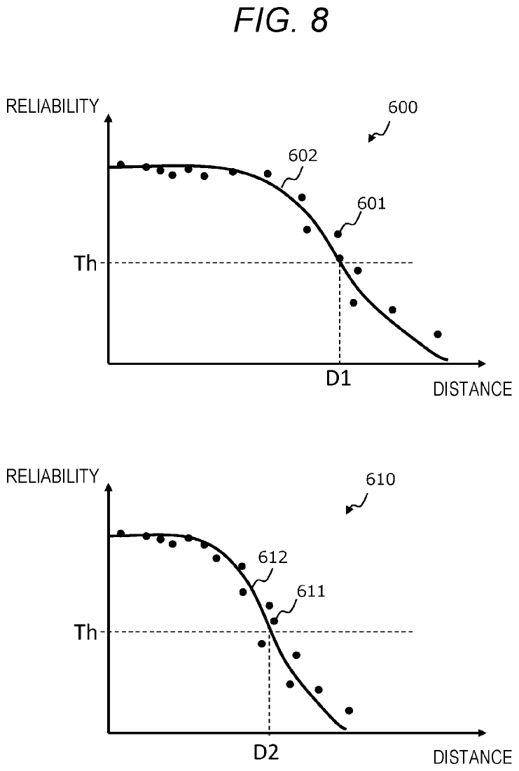

FIG. 8 illustrates an example of a method of calculating the information on the correlation between the detection distance and the reliability. A graph 600 of FIG. 8 illustrates a regression curve 602 for a sample 601 of each combination of the detection distance and the reliability in a normal external environment. In a case of a sensor such as a radar or LiDAR that observes a reflected wave of an electromagnetic wave, attenuation of the reflected wave increases as the detection distance increases, and thus the reliability decreases. In addition, since the resolution of a camera-based sensor with respect to a distant object decreases, the reliability also decreases. Therefore, in any sensor, time-series data indicating that the reliability decreases according to the detection distance is obtained, and a correlation graph such as the graph 600 can be obtained based on the time-series data.

The graph 610 of FIG. 8 illustrates a regression curve 612 for a sample 611 of each combination of the detection distance and the reliability under bad weather, such as heavy rain. An electromagnetic wave sensor such as a radar or a LiDAR obtains time-series data indicating that an attenuation rate of a reflected wave increases due to an influence of raindrops, water vapor, or the like under bad weather, and the reliability with respect to the detection distance thus becomes lower than that in a normal time. Also in a camera-based sensor, the visibility becomes poorer as the distance increases under bad weather, and noise is generated in parallax information for calculating the distance based on a plurality of images or in the contour of the target object in the recognition processing, and the same result is obtained. Therefore, the graph 610 has a shape in which the reliability decreases at a shorter detection distance as compared with the graph 600.

The correlation between the detection distance and the reliability may be statistically processed uniformly for all pieces of detection information of the sensor, or may be classified by a specific index and statistically processed for each classification. For example, some sensors may have a performance difference depending on the detection angle. In a he camera-based sensor, the detection performance is degraded at a boundary portion of a viewing angle, and the detection performance is degraded as the angle becomes wider in a radar or sonar. Therefore, it is preferable to determine a relationship between the detection distance and the reliability of the sensor by performing statistical processing of the detection information for each predetermined angle range. In addition, some sensors may have a performance difference depending on the type of a detection target. Some electromagnetic wave sensors are difficult to perform detection because a reflectance of an electromagnetic wave varies depending on a target object. It is possible to obtain the correlation between the detection distance and the reliability with higher accuracy by performing statistical processing of each type of detection target instead of performing statistical processing in a mixed manner.

Once S505 of FIG. 7 ends, the sensor detectable zone-determining unit 12 determines the sensor detectable zone data for the sensor group based on the correlation information (S506). As illustrated in FIG. 4, the sensor detectable zone data is expressed as, for example, a set of detectable distances D for the respective predetermined classifications. The detectable distance D is obtained by obtaining a range of the detection distance at which the reliability can be maintained to be equal to or higher than a predetermined threshold Th based on the information on the correlation between the detection distance and the reliability for each predetermined classification obtained in S504. For example, a detection distance D1 corresponds the detectable distance D in the graph 600 of FIG. 8, and the detection distance D2 corresponds to the detectable distance D in the graph 610.

Note that, here, the detectable distance D is calculated by calculating a regression curve indicating the correlation between the detection distance and the reliability and then obtaining an intersection with the threshold Th, but the implementation means is not limited to this method. As in the graph 350 of FIG. 4, the correlation between the detection distance and the reliability may be discretely expressed and then the detectable distance D may be obtained. In addition, the detectable zone data is not necessarily an expression of a boundary value of the detectable distance D, and there is no problem even if the detectable zone data is information itself on the correlation (regression curve or the like) of the reliability with respect to the detection distance.

Once S506 of FIG. 7 ends, the sensor detectable zone-determining unit 12 stores the sensor detectable zone data obtained in S505 in the sensor detectable zone data group 34, ends the processing of the sensor group, and performs processings S501 to S507 of the next sensor group. Once the processing of all the sensor groups is completed, the sensor detectable zone determination processing ends.

(Surroundings Detectable Zone Determination Processing and Surroundings Redundancy Detectable Zone Determination Processing)

The surroundings detectable zone-determining unit 13 determines the surroundings detectable zone which is a zone where an environmental element such as an obstacle around the vehicle 2 can be detected by using the external environment sensor group 4 based on the sensor detectable zone (sensor detectable zone data group 34) of each sensor group determined by the sensor detectable zone-determining unit 12, and stores the surroundings detectable zone in the storage unit 30 as the surroundings detectable zone data group 35.

Similarly, the surroundings redundancy detectable zone-determining unit 14 determines, based on the sensor detectable zone data group 34, the surroundings redundancy detectable zone which is a zone where an environmental element such as an obstacle around the vehicle 2 can be redundantly detected by two or more sensor groups of the external environment sensor group 4, and stores the surroundings redundancy detectable zone in the storage unit 30 as a part of the surroundings detectable zone data group 35.

As a method of determining the surroundings detectable zone and the surroundings redundancy detectable zone, various methods can be considered according to an expression form of the sensor detectable zone data group 34. For example, it is assumed that the detectable zone of each sensor group of the external environment sensor group 4 is expressed by connecting the detectable distances D for the respective detection angles. In this case, the respective sensor detectable zones are expressed in arbitrary shapes like the zones 111 to 117 in FIG. 2, and for example, the surroundings detectable zone may be defined to have a shape in which the shapes of the sensor detectable zones are combined (a zone 701 in FIG. 9), and the surroundings redundancy detectable zone may be defined to have a shape in which the shapes of two or more sensor detectable zones whose shapes overlap each other are combined (zones 702 to 704 in FIG. 9).

In addition, for example, it is assumed that the detectable zone of each sensor group of the external environment sensor group 4 is expressed as the information on the correlation between the detection distance and the reliability. In this case, since the reliability information at each polar coordinate (detection angle, detection distance) exists in the detectable zone of each sensor group, the detection reliability of each sensor group at each position around the vehicle 2 can be obtained from the reliability information. Therefore, at each position around the vehicle 2, a probabilistic consolidation of the detection reliability included in the detection information of each sensor group represented by the sensor detectable zone data group 34 may be set as the surroundings detectable zone or the surroundings redundancy detectable zone. Note that the detection reliability is handled as probabilistic information.

Assuming that detection reliabilities of sensor groups 1 to k (k is a natural number of 2 or more) at coordinates (X,Y) around the vehicle 2 are r1(X,Y), . . . , and rk(X,Y), a detection reliability R at the coordinates (X,Y) of the surroundings detectable zone is obtained by, for example, the following formula.

R=1−{(1−r1(X,Y))× . . . ×(1−rk(X,Y))}, which represents a probability that an environmental element to be detected can be detected by one or more sensor groups. In a case where this is expressed on a grid map, an expression like the surroundings detectable zone data group 35 of FIG. 5 is obtained.

Similarly, a redundancy detection reliability Rr at coordinates (X,Y) of the surroundings redundancy detectable zone is obtained by, for example, the following formula.

Rr=R−{r1(X,Y)× . . . ×(1−rk(X,Y))}{(1−r1(X,Y)× . . . ×rk(X,Y)}, which represents a probability that an environmental element to be detected can be detected by two or more sensor groups, and is expressed by a grid map or the like similarly to the surroundings detectable zone.

In a case where the surroundings detectable zone or the surroundings redundancy detectable zone is defined using the detection reliability R and the redundancy detection reliability Rr calculated as described above, the surroundings detectable zone or the surroundings redundancy detectable zone may be defined as the detection reliability or the redundancy detection reliability expressed on a grid map, may be defined as zones where the reliability is equal to or higher than a predetermined threshold, or may be expressed as the zone boundaries instead of a grid map.

In addition, in a case where the sensor detectable zone data is defined for each type of environmental element, the surroundings detectable zone and the surroundings redundancy detectable zone may be obtained using only the sensor detectable zone data of a predetermined type, or may be obtained using the sensor detectable zone data of a plurality of arbitrary types. In a case of obtaining the surroundings detectable zone and the surroundings redundancy detectable zone by using a plurality of types, the surroundings detectable zone and the surroundings redundancy detectable zone may be obtained after consolidating the sensor detectable zone data of the plurality of types for each sensor group, or may be obtained by consolidating the sensor detectable zone data for each type. In a case of consolidating the sensor detectable zone data of the plurality of types for each sensor group, for example, the sensor detectable zone data may be consolidated by taking the minimum value or the maximum value of the detectable distance D or the detection reliability, or the sensor detectable zone data may be consolidated by calculating the detection reliability weighted according to the type.

The surroundings detectable zone-determining unit 13 and the surroundings redundancy detectable zone-determining unit 14 can determine the surroundings detectable zone and the surroundings redundancy detectable zone, respectively, as described above based on the relationship between the detection distance and the reliability determined by the sensor detectable zone-determining unit 12 for each sensor group of the external environment sensor group 4.

(Sensor Detection Information Consolidation Processing)

The sensor detection information-consolidating unit 15 generates the consolidated detection information data group 36 obtained by consolidating detection information of a plurality of external environment sensors based on the sensor detection information data group 31 and the vehicle information data group 32 acquired from the information acquisition unit 11, and stores the generated consolidated detection information data group 36 in the storage unit 30.

The sensor detection information consolidation processing corresponds to the sensor fusion processing for the detection information. The surroundings detectable zone determination processing and the surroundings redundancy detectable zone determination processing described above aim to obtain a performance limit of an external environment sensor in an external environment at that time, whereas the sensor detection information consolidation processing aims to consolidate the detection information of the external environment sensors to understand the traveling environment around the vehicle 2 with a high reliability. For example, detection information for environmental elements such as another vehicle and a white line are consolidated, and a zone blocked by a detection target is specified. The zone blocked by the detection target is a zone (blind spot zone) that is originally detectable by an external environment sensor but is blocked by an obstacle or the like and is thus undetectable. The cruise control information-generating unit 17 needs to perform cruise control while being conscious of not only an environmental element detected by the external environment sensor group 4 but also the presence of a potential obstacle hidden in a blind spot zone of such external environment sensors.

(Cruise Control Mode Picking Processing)

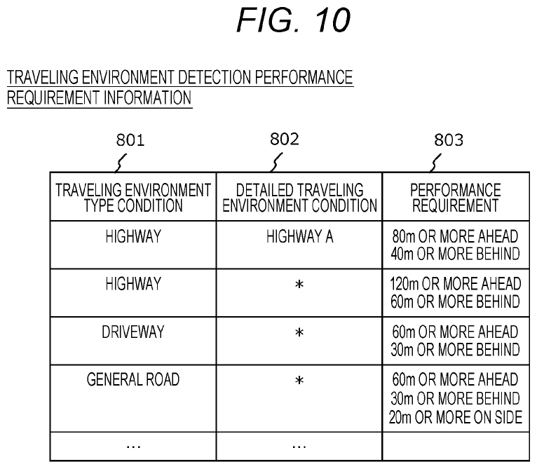

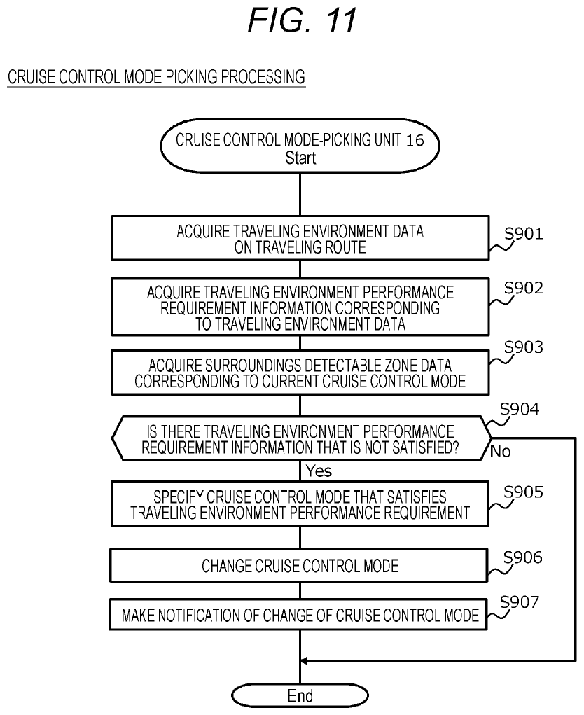

Processing performed by the cruise control mode-picking unit 16 will be described with reference to FIGS. 10 and 11. The cruise control mode-picking unit 16 picks the cruise control mode of the vehicle system 1 based on the traveling environment data group 33, the surroundings detectable zone data group 35, and the system parameter data group 38 including the system state (the failure state, the occupant instruction mode, or the like) of the vehicle system 1 or the cruise control device 3. In addition to shifting the vehicle system 1 to an appropriate system state in accordance with the failure state of the vehicle system 1 and an automated driving instruction from an occupant, the cruise control mode is picked based on the detection performance requirement for a sensor in a traveling environment and an actual limited performance of the sensor indicated by the surroundings detectable zone or the surroundings redundancy detectable zone.

FIG. 10 illustrates an example of traveling environment detection performance requirement information which is information indicating a detection performance requirement for a sensor in a traveling environment. It is assumed that the traveling environment detection performance requirement information is a type of system parameter that determines the behavior of the vehicle system 1, and is stored in the system parameter data group 38.

A traveling environment type condition 801 represents a condition of a road type targeted by the entry, and a highway, a driveway (excluding a highway), a general road, and the like are designated.

A detailed traveling environment condition 802 represents a detailed condition related to a traveling environment targeted by the entry, and is expressed using, for example, a specific road name, a road attribute (the number of lanes, a maximum curvature, whether or not road construction is being performed, or the like), and the like. In FIG. 10, “highway A” is illustrated as an example in which a specific road name is used as the detailed condition. Note that “*” is a wildcard, which means that an arbitrary condition is applied.

A performance requirement 803 represents the detection performance required for the external environment sensor group 4 under the traveling environment condition expressed by a combination of the traveling environment type condition 801 and the detailed traveling environment condition 802. For example, in FIG. 10, the performance requirement 803 is expressed by a combination of a detection direction (ahead, behind, or side) and a detection distance with respect to the vehicle 2. Note that a specific zone shape required for each detection direction, ahead, behind, or side, is appropriately defined according to the detection distance.

FIG. 11 is a flowchart for describing the cruise control mode picking processing. The cruise control mode-picking unit 16 picks the cruise control mode of the vehicle system 1 by performs processings of S901 to S907, and performs processing of changing and making notification of the cruise control mode as necessary.

In S901, the cruise control mode-picking unit 16 acquires traveling environment data on the traveling route from the traveling environment data group 33. Then, in S902, a corresponding performance requirement is specified from the traveling environment detection performance requirement information illustrated in FIG. 10 with reference to road information included in the traveling environment data. For example, in a case where the vehicle 2 is traveling on a highway other than highway A, in a row in which the traveling environment type condition 801 is “highway” and the detailed traveling environment condition 802 is “*”, “120 m or more ahead and 60 m or more behind” indicated in the performance requirement 803 corresponds to the performance requirement for the external environment sensor group 4.

Subsequently, in S903, the cruise control mode-picking unit 16 acquires the surroundings detectable zone or the surroundings redundancy detectable zone according to the current cruise control mode from the surroundings detectable zone data group 35. The cruise control mode of the vehicle system 1 is defined by, for example, an autonomous driving level. According to the standard of J3016 of Society of Automotive Engineers (SAE), the driver is responsible for safe driving in a case where the autonomous driving level is Level 2 or lower, and the system is responsible for safe driving in a case where the autonomous driving level is Level 3 or higher. Therefore, in a case where the vehicle system 1 operates in the cruise control mode corresponding to the autonomous driving level 3 or higher, it is necessary to form a redundant system configuration in principle in order to cope with a failure or a malfunction of the sensor/actuator. Therefore, in a case where the current cruise control mode corresponds to the autonomous driving level 3 or higher, it is necessary to satisfy a performance requirement by the redundancy, and thus the surroundings redundancy detectable zone determined by the surroundings redundancy detectable zone-determining unit 14 is referred to in the surroundings detectable zone data group 35. On the other hand, in a case where the current cruise control mode corresponds to the autonomous driving level 2 or lower, the redundancy is unnecessary. Therefore, it is sufficient if the surroundings detectable zone determined by the surroundings detectable zone-determining unit 13 is referred to in the surroundings detectable zone data group 35.

Next, in S904, the cruise control mode-picking unit 16 compares the performance requirement acquired in S902 with the data of the surroundings detectable zone or the surroundings redundancy detectable zone acquired in S903, and determines whether or not the performance requirement is satisfied. In the example of FIG. 10, in the performance requirement 803, a performance requirement for the external environment sensor group 4 is expressed by a combination of the detection direction and the detectable distance with respect to the vehicle 2, but as described above, it is assumed that a specific zone shape required for each detection direction is appropriately defined according to the detection distance. Therefore, it is possible to convert the performance requirement acquired in S902 into information on the zone and compare the information with the data of the surroundings detectable zone and the surroundings redundancy detectable zone. On the other hand, the data of the surroundings detectable zone and the surroundings redundancy detectable zone acquired in S903 may be expressed in a form of a detectable distance for each detection direction in conformity with the expression of the performance requirement in the traveling environment detection performance requirement information, and be compared with the performance requirement acquired in S902.

In a case where the zone indicated by the performance requirement falls within the range of the surroundings detectable zone or the surroundings redundancy detectable zone as a result of the comparison, which means that the external environment sensor group 4 satisfies the performance requirement for the current cruise control mode, the cruise control mode picking processing ends without changing the cruise control mode (No in S904). On the other hand, in a case where the zone indicated by the performance requirement does not fall within the range of the surroundings detectable zone or the surroundings redundancy detectable zone, it is determined that the external environment sensor group 4 does not satisfy the performance requirement for the current cruise control mode, and the processing proceeds to S905 (Yes in S904).

In S905, the cruise control mode-picking unit 16 specifies the cruise control mode that satisfies the traveling environment performance requirement. Here, for example, it is assumed that there are three cruise control modes including a manual driving mode, an autonomous driving level 2 mode, and an autonomous driving level 3 mode, and that the autonomous driving level 3 mode is currently selected. In this case, in a case where it is determined in S904 that the performance requirement of the autonomous driving level 3 mode is not satisfied, it is determined next whether or not the performance requirement of the autonomous driving level 2 mode is satisfied. In a case where the performance requirement of the autonomous driving level 2 mode is satisfied, the autonomous driving level 2 mode is selected. In a case where the performance requirement of the autonomous driving level 2 mode still cannot be satisfied, the manual driving mode is selected. In S905, it is determined whether or not the performance requirement acquired in S902 is satisfied from the higher cruise control mode to the lower cruise control mode as described above, and the cruise control mode determined to satisfy the performance requirement is selected.

Although the autonomous driving level has been described as an example here for the sake of explanation, the mode may be subdivided by defining the level of the automated driving function. For example, it is also possible to divide the autonomous driving level 2 mode into a mode in which the lane change is automatically determined, a mode in which the lane change cannot be performed unless a manual instruction is given, a mode in which only lane following is allowed, and the like. For example, in a case of allowing only lane following, the performance requirement for the side direction is unnecessary. Therefore, it is also possible to define the detection performance requirement for each cruise control mode separately from the traveling environment, and pick an appropriate cruise control mode based on whether or not the detection performance requirements for both the traveling environment and the cruise control mode are satisfied. In this case, a minimum condition for enabling cruise control in the road environment is described as the detection performance requirement for the traveling environment, and the stricter condition is defined as the detection performance requirement for the cruise control mode.

Once the cruise control mode is selected in S905, processing of changing the cruise control mode is performed in S906. The final cruise control mode is determined through arbitration between devices for securing consistency as the entire vehicle system 1, interaction with a driving vehicle for handing over the control to the driver, and the like. Then, in S907, notification of the determined cruise control mode is made to the related functions and peripheral devices, and this processing ends.

The cruise control mode-picking unit 16 can pick, based on the surroundings detectable zone determined by the surroundings detectable zone-determining unit 13 or the surroundings redundancy detectable zone determined by the surroundings redundancy detectable zone-determining unit 14, the cruise control mode according to the autonomous driving level that can be supported by the vehicle 2 as described above, and select the cruise control mode to be adopted in the vehicle system 1.

(Cruise Control Planning Processing)

The cruise control information-generating unit 17 performs cruise control planning processing on the vehicle 2 in such a way that the vehicle 2 can travel safely and comfortably toward a destination indicated in the traveling route of the traveling environment data group 33. In this cruise control planning processing, a basic processing flow is to generate a safe and comfortable traveling trajectory of the vehicle 2 while avoiding an obstacle detected by the external environment sensor group 4 and generate a control command value for following the travel trajectory, according to traffic rules represented by the traveling environment data group 33 and the consolidated detection information data group 36. The present invention is characterized in that the surroundings detectable zone data group 35 is further utilized in generating a safe and comfortable traveling trajectory.

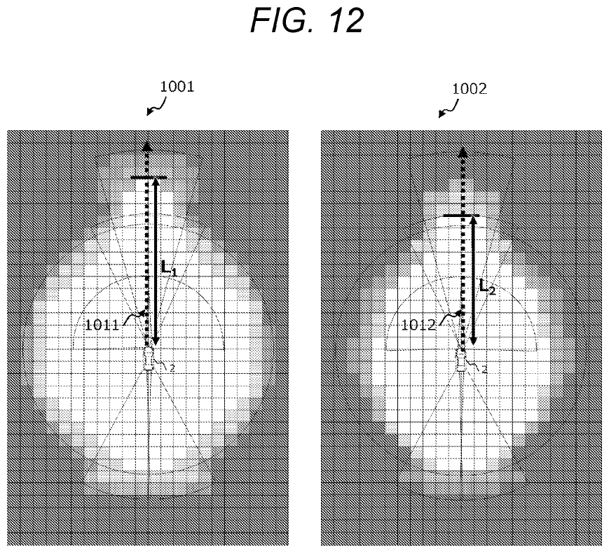

The performance limit of the external environment sensor group 4 changes according to the external environment. FIG. 12 illustrates an example of the surroundings detectable zone that changes according to the external environment. The left diagram 1001 of FIG. 12 illustrates a situation in a case of a normal external environment, and the right diagram 1002 illustrates a situation where the detection performance of the external environment sensor group 4 is degraded due to bad weather or the like in the external environment. In bad weather, the detectable distance of the external environment sensor becomes short, so that the surroundings detectable zone also becomes narrow. At a position beyond the surroundings detectable zone, even if there is no detection information, there is a possibility that the external environment sensor group 4 has not been able to detect an obstacle. In a case where the traveling trajectory is generated similarly to that in a normal time without being conscious of the degradation in detection performance of the external environment sensor due to bad weather or the like, there is a risk of causing collision with an obstacle or deterioration in ride comfort due to sudden deceleration.

Therefore, the cruise control information-generating unit 17 generates, for example, a trajectory on which the vehicle 2 is to travel at such a speed that the vehicle 2 can safely stop in the range of the surroundings detectable zone. A distance from the start of deceleration to the stop of the vehicle 2 is v²/2α, in which a represents an allowable deceleration in the vehicle 2 and v represents the current speed of the vehicle 2. It is necessary to control the speed of the vehicle 2 in such a way as to satisfy at least L>v²/2α, in which L represents a distance from the current position of the vehicle 2 to a location intersecting with a region having a high potential risk on the traveling route. However, in this case, sudden deceleration is applied when the condition is no longer satisfied. Therefore, it is desirable to decelerate slowly before the condition is not actually satisfied. For example, there is a method in which a time to braking (TTB) until the vehicle 2 reaches a point where the condition is not satisfied is introduced as an index, and the speed of the vehicle 2 is adjusted based on the TTB. The TTB can be calculated by (L−v²/2α)/v. In order to avoid sudden deceleration, for example, deceleration (<α) may be gradually applied when the TTB becomes equal to or less than a predetermined value, or the speed may be controlled in such a way that the TTB becomes equal to or more than a predetermined value.

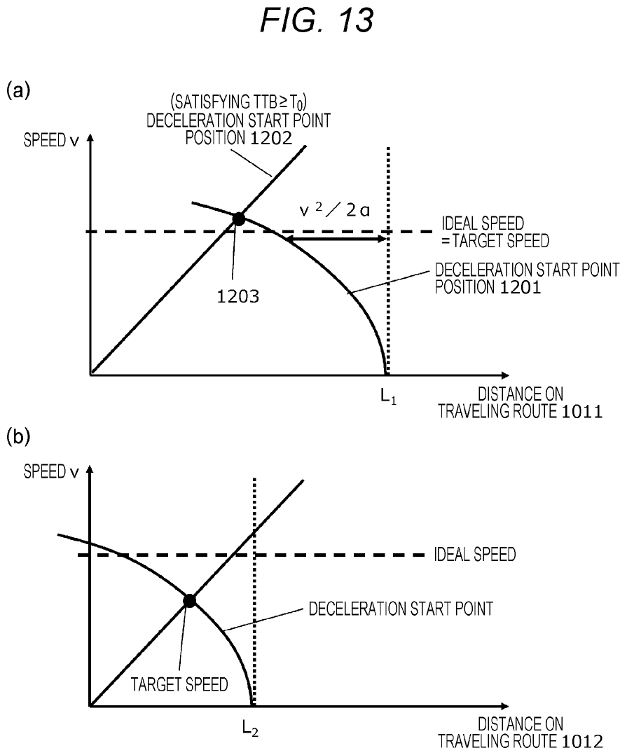

FIG. 13 is a diagram illustrating an example of a method of calculating a target speed according to the surroundings detectable zone in a normal time and bad weather. In FIGS. 13(a) and 13(b), the horizontal axis represents the distance on the traveling route, and the vertical axis represents the speed of the host vehicle 2. FIG. 13(a) corresponds to a diagram in a case of calculating a target speed on a straight route 1011 in a normal time in FIG. 12, and FIG. 13(b) corresponds to a diagram in a case of calculating a target speed on a straight route 1012 in bad weather in FIG. 12.

Normally, at a distance L1 in the left diagram 1001 of FIG. 12, the straight route 1011 of the vehicle 2 intersects with a zone outside the surroundings detectable zone, that is, a zone where the obstacle detection performance by the external environment sensor group 4 is low. As illustrated in FIG. 13(a), a deceleration start point at which the vehicle 2 stops before the distance L1 is a position before v²/2α from L1 (deceleration start point position 1201). On the other hand, in order to satisfy TTB TO, the deceleration start point needs to be TO v ahead of the current position (deceleration start point position 1202). An intersection 1203 of the deceleration start point position 1201 and the deceleration start point position 1202 is the maximum speed satisfying the condition. In this example, since the intersection 1203 exceeds an ideal speed (legal speed limit or the like), the target speed is set to the ideal speed.

On the other hand, in bad weather, as illustrated in the right diagram 1002 of FIG. 12, a distance L2 at which the straight route 1012 of the vehicle 2 intersects with a zone outside the surroundings detectable zone, that is, a zone where the obstacle detection performance by the external environment sensor group 4 is low, is smaller than the distance L1 in a normal time (L2<L1). Therefore, as illustrated in FIG. 13(b), the intersection satisfying the condition is lower than the ideal speed. This means that the vehicle 2 needs to travel at a lower speed than in a normal time, and corresponds to that a person drives the vehicle at a lower speed for safety when front visibility is poor due to bad weather or the like.

Although it has been assumed here that there is no obstacle, in actual implementation, the detection by the external environment sensor may be blocked by an obstacle. As described above, information on the blind spot zone caused by blocking by an obstacle is specified by the sensor detection information consolidation processing performed by the sensor detection information-consolidating unit 15. It is desirable that the cruise control information-generating unit 17 obtains the target speed by the above-described means after reflecting an influence of the blind spot zone on the surroundings detectable zone.

(Cruise Control Information Generation Processing)

The cruise control information-generating unit 17 generates the cruise control information for the vehicle 2 based on the cruise control mode of the vehicle system 1 picked by the cruise control mode-picking unit 16 performing the cruise control planning processing and the control command value determined by the cruise control information-generating unit 17 performing the cruise control planning processing. As a result, the cruise control information can be generated based on the detection information of each sensor of the external environment sensor group 4 and at least one of the surroundings detectable zone determined by the surroundings detectable zone-determining unit 13 or the surroundings redundancy detectable zone determined by the surroundings redundancy detectable zone-determining unit 14. Therefore, it is possible to perform cruise control in sufficient consideration of the detection performance of the sensor.

According to the above embodiment, the detectable zone is dynamically calculated by performing statistical analysis using the information on the detection position and the detection reliability included in the detection information of the external environment sensor. As a result, it is possible to quantify a zone of the performance limit of the external environment sensor that changes depending on an external environment, and it is possible to perform cruise control in consideration of performance degradation of the external environment sensor.

According to the above embodiment, since it is possible to quantify the performance limit of the sensor that changes according to the external environment, it is possible to flexibly set the cruise control mode according to the performance limit. For example, it is possible to appropriately select the cruise control mode in which the vehicle system 1 can ensure the function by quantitatively comparing the performance requirement of the cruise control mode in the traveling environment with the performance limit at that time. In a case where the performance limit of the sensor is not quantified, it cannot be appropriately determined whether or not the performance requirement is satisfied, so that the cruise control mode has to be picked in such a way as to give greater weight to safety. As a result, even in a case where the automated driving could be originally continued, the automated driving is stopped, and availability as the automated driving function is lowered. On the other hand, in the present invention, it is possible to continue the function to the maximum while securing safety, and as a result of which the availability is improved.

According to the above embodiment, since it is possible to quantify the performance limit of the sensor that changes according to the external environment, a safe cruise control plan according to the performance limit can be made. It is possible to travel at a safe speed when visibility is poor due to bad weather or the like by performing control in such a way as to travel at a speed at which the vehicle can safely stop within a range of a zone where the external environment sensor group 4 can detect an obstacle with a high reliability. In a case where the performance limit of the sensor is not quantified, a safe traveling speed cannot be appropriately determined, so that the vehicle has to travel at a lower speed to secure safety. As a result, there is a problem that excessive deceleration is made, and ride comfort given to the occupant deteriorates. On the other hand, in the present invention, it is possible to continue traveling with appropriate deceleration while securing safety, and thus there is an effect that ride comfort is improved.

According to one embodiment of the present invention described above, the following effects are exhibited.

(1) The cruise control device 3, which is an ECU mounted on the vehicle 2, includes: the sensor detectable zone-determining unit 12 that determines the sensor detectable zone representing a zone where an environmental element present around the vehicle 2 is detectable by the external environment sensor group 4 mounted on the vehicle 2 based on detection information of the external environment sensor group 4; the cruise control information-generating unit 17 that generates the cruise control information for the vehicle 2 based on the detection information of the external environment sensor group 4 and the sensor detectable zone determined by the sensor detectable zone-determining unit 12; and the information output unit 18 that outputs the cruise control information generated by the cruise control information-generating unit 17. With this configuration, it is possible to provide an ECU capable of flexibly and safely continuing cruise control in spite of performance degradation of a sensor due to a change in external environment.

(2) The detection information of the external environment sensor group 4 includes position information indicating a position of the environmental element and reliability information of the detection information. The sensor detectable zone-determining unit 12 determines a relationship between a detection distance and a reliability of the external environment sensor group 4 based on the position information and the reliability information (S505), and determines the sensor detectable zone based on the relationship (S506). With this configuration, the sensor detectable zone according to the detection performance of the external environment sensor group 4 can be appropriately determined.

(3) In S505, the sensor detectable zone-determining unit 12 determines the relationship between the detection distance and the reliability based on time-series data of the detection information of the external environment sensor group 4. In this way, even in a case where the detection performance of the external environment sensor group 4 fluctuates due to an influence of an external environment such as weather, and the relationship between the detection distance and the reliability changes accordingly, the sensor detectable zone can be determined by appropriately reflecting the change.

(4) In S506, the sensor detectable zone-determining unit 12 can determine, as the sensor detectable zone, a range of the detection distance at which reliability is equal to or higher than the predetermined threshold Th based on the relationship between the detection distance and the reliability. With this configuration, the sensor detectable zone according to the relationship between the detection distance and the reliability of the external environment sensor group 4 can be appropriately determined.

(5) Furthermore, the sensor detectable zone-determining unit 12 can determine the sensor detectable zone by determining the relationship between the detection distance and the reliability for each predetermined angle range. With this configuration, the sensor detectable zone can be appropriately determined for a sensor such as a camera or a radar that has a performance difference depending on a detection angle.

(6) The cruise control device 3 further includes the surroundings detectable zone-determining unit 13 that determines, for a plurality of sensors of the external environment sensor group 4 mounted on the vehicle 2, the surroundings detectable zone representing a zone where an environmental element around the vehicle 2 can be detected using the plurality of sensors. The cruise control information-generating unit 17 generates the cruise control information based on the detection information of the group of external environment sensor group 4 and the surroundings detectable zone determined by the surroundings detectable zone-determining unit 13. With this configuration, it is possible to generate the cruise control information for implementing a safe and comfortable travel trajectory of the vehicle 2 in consideration of the performance limit of the external environment sensor group 4.

(7) The surroundings detectable zone-determining unit 13 determines the surroundings detectable zone based on the relationship between the detection distance and the reliability determined for each of the plurality of sensors of the external environment sensor group 4 by the sensor detectable zone-determining unit 12. With this configuration, in a case where various sensors are mounted on the vehicle 2 as the external environment sensor group 4, the surroundings detectable zone can be appropriately set.

(8) The reliability information in the detection information of the external environment sensor group 4 is probabilistic information indicating a probability that an environmental element to be detected exists. The surroundings detectable zone-determining unit 13 can determine the surroundings detectable zone as illustrated in FIG. 5, for example, by probabilistically consolidating the probabilistic information included in the detection information of each of the plurality of sensors of the external environment sensor group 4 at each position around the vehicle 2. In this way, by finely setting the sensor detectable zone around the vehicle 2, it is possible to generate the cruise control information capable of implementing a safer and more comfortable travel trajectory of the vehicle 2.

(9) The cruise control device 3 further includes the surroundings redundancy detectable zone-determining unit 14 that determines the surroundings redundancy detectable zone representing a zone where an environmental element around the vehicle 2 can be redundantly detected by at least two or more sensors among the plurality of sensors of the external environment sensor group 4 mounted on the vehicle 2. As a result, the cruise control information-generating unit 17 generates the cruise control information based on the detection information of the external environment sensor group 4 and at least one of the surroundings detectable zone determined by the surroundings detectable zone-determining unit 13 or the surroundings redundancy detectable zone determined by the surroundings redundancy detectable zone-determining unit 14. With this configuration, for example, even in a case where a redundant system configuration is required as in a case of operating in the cruise control mode corresponding to the autonomous driving level 3 or higher, it is possible to generate the cruise control information for implementing a safe and comfortable travel trajectory of the vehicle 2 in consideration of the requirement.

(10) The cruise control device 3 further includes the cruise control mode-picking unit 16 that picks the cruise control mode according to the autonomous driving level that can be supported by the vehicle 2 based on the surroundings detectable zone determined by the surroundings detectable zone-determining unit 13 or the surroundings redundancy detectable zone determined by the surroundings redundancy detectable zone-determining unit 14. With this configuration, the applicable autonomous driving level can be appropriately determined in consideration of the external environment of the vehicle 2, and the cruise control mode can be set according to the autonomous driving level.

(11) The external environment sensor group 4 can include a sensor that detects an object based on a reflected wave of an emitted electromagnetic wave, such as a radar or a LiDAR. In this case, the reliability information included in the detection information of the sensor can be information based on any one of a reception strength or a signal-to-noise ratio of the reflected wave. In this way, it is possible to appropriately set the reliability information by reflecting a probability that an environmental element to be detected by the sensor exists.

Note that the embodiment described above is an example, and the present invention is not limited thereto. That is, various applications are possible, and various embodiments are included in the scope of the present invention.

For example, it has been described in the above embodiment that the threshold Th in FIG. 8 is a fixed value, but the threshold Th may be dynamically changed according to the system state of the vehicle 2. For example, in a case where the cruise control mode of the vehicle 2 selected according to the picking result of the cruise control mode-picking unit 16 is equal to or higher than the autonomous driving level 3 and the system needs to be responsible for safe driving, it is better to make a determination in such a way as to give greater weight to safety, and thus the threshold Th may be set high. In this manner, the sensor detectable zone can be set more flexibly by determining the threshold Th used when the sensor detectable zone-determining unit 12 determines the sensor detectable zone based on the result of picking the cruise control mode by the cruise control mode-picking unit 16.

For example, in the above embodiment, in the cruise control device 3, each processing is assumed to be performed by the same processing unit 10 and storage unit 30, but a plurality of processing units 10 or a plurality of storage units 30 may be provided, and each processing may be performed by the plurality of different processing units and storage units. In this case, for example, processing software having a similar configuration is mounted in each storage unit, and the respective processing units perform the processing in a cooperative manner.

In addition, each processing performed by the cruise control device 3 is implemented by executing a predetermined operation program using a processor and a RAM, but can also be implemented by unique hardware as necessary. In addition, in the above embodiment, the external environment sensor group, the vehicle sensor group, and the actuator group are described as individual devices, but any two or more of them may be combined as necessary.

In addition, the drawings illustrate control lines and information lines considered to be necessary for describing the embodiment, and do not necessarily illustrate all the control lines and information lines included in an actual product to which the present invention is applied. In practice, it can be considered that almost all configurations are interconnected.

### REFERENCE SIGNS LIST

1 vehicle system
2 vehicle
3 cruise control device
4 external environment sensor group
5 vehicle sensor group
6 map information management device
7 actuator group
10 processing unit
11 information acquisition unit
12 sensor detectable zone-determining unit
13 surroundings detectable zone-determining unit
14 surroundings redundancy detectable zone-determining unit
15 sensor detection information-consolidating unit
16 cruise control mode-picking unit
17 cruise control information-generating unit
18 information output unit
30 storage unit
31 sensor detection information data group
32 vehicle information data group
33 traveling environment data group
34 sensor detectable zone data group
35 surroundings detectable zone data group
36 consolidated detection information data group
37 cruise control information data group
38 system parameter data group
40 communication unit

1. An electronic control device mounted on a vehicle, the electronic control device comprising:
a sensor detectable zone-determining unit that determines a sensor detectable zone representing a zone where an environmental element present around the vehicle is detectable by a sensor mounted on the vehicle based on detection information of the sensor;
a cruise control information-generating unit that generates cruise control information for the vehicle based on the detection information of the sensor and the sensor detectable zone determined by the sensor detectable zone-determining unit; and
an information output unit that outputs the cruise control information generated by the cruise control information-generating unit.

2. The electronic control device according to claim 1,
wherein the detection information includes position information indicating a position of the environmental element and reliability information of the detection information, and
the sensor detectable zone-determining unit determines a relationship between a detection distance and a reliability of the sensor based on the position information and the reliability information, and determines the sensor detectable zone based on the relationship.

3. The electronic control device according to claim 2, wherein the sensor detectable zone-determining unit determines the relationship based on time-series data of the detection information.

4. The electronic control device according to claim 2, wherein the sensor detectable zone-determining unit determines a range of the detection distance at which the reliability is equal to or higher than a predetermined threshold as the sensor detectable zone based on the relationship.

5. The electronic control device according to claim 4, further comprising a cruise control mode-picking unit that picks a cruise control mode according to a content of automated driving of the vehicle,
wherein the threshold is determined based on a result of picking the cruise control mode by the cruise control mode-picking unit.

6. The electronic control device according to claim 2, wherein the sensor detectable zone-determining unit determines the relationship for each predetermined angle range to determine the sensor detectable zone.

7. The electronic control device according to claim 2, further comprising a surroundings detectable zone-determining unit that determines, for a plurality of sensors mounted on the vehicle, a surroundings detectable zone representing a zone where the environmental element around the vehicle is detectable by using the plurality of sensors,
wherein the cruise control information-generating unit generates the cruise control information based on the detection information of the sensor and the surroundings detectable zone determined by the surroundings detectable zone-determining unit.

8. The electronic control device according to claim 7, wherein the surroundings detectable zone-determining unit determines the surroundings detectable zone based on the relationship determined for each of the plurality of sensors by the sensor detectable zone-determining unit.

9. The electronic control device according to claim 8, wherein the reliability information is probabilistic information indicating a probability that the environmental element exists, and
the surroundings detectable zone-determining unit determines the surroundings detectable zone by probabilistically consolidating the probabilistic information included in the detection information of each of the plurality of sensors at each position around the vehicle.

10. The electronic control device according to claim 7, further comprising a surroundings redundancy detectable zone-determining unit that determines a surroundings redundancy detectable zone representing a zone where the environmental element around the vehicle is redundantly detectable by at least two or more sensors among the plurality of sensors,
wherein the cruise control information-generating unit generates the cruise control information based on the detection information of the sensor and at least one of the surroundings detectable zone determined by the surroundings detectable zone-determining unit or the surroundings redundancy detectable zone determined by the surroundings redundancy detectable zone-determining unit.

11. The electronic control device according to claim 10, further comprising a cruise control mode-picking unit that picks a cruise control mode according to an autonomous driving level supportable by the vehicle, based on the surroundings detectable zone determined by the surroundings detectable zone-determining unit or the surroundings redundancy detectable zone determined by the surroundings redundancy detectable zone-determining unit.

12. The electronic control device according to claim 2, wherein the sensor is a sensor that detects an object based on a reflected wave of an emitted electromagnetic wave, and
the reliability information is information based on any one of a reception strength or a signal-to-noise ratio of the reflected wave.

13. An electronic control device mounted on a vehicle, the electronic control device comprising:
a surroundings detectable zone-determining unit that determines a surroundings detectable zone representing a zone where an environmental element present around the vehicle is detectable based on detection information of a sensor mounted on the vehicle;
a cruise control information-generating unit that generates cruise control information for the vehicle based on the detection information of the sensor and the surroundings detectable zone determined by the surroundings detectable zone-determining unit; and
an information output unit that outputs the cruise control information generated by the cruise control information-generating unit.
